(19) United States
(12) Patent Application Publication
(10) Pub. No.: US 2020/0026866 A1
(43) Pub. Date: Jan. 23, 2020

(54) METHOD AND DEVICE FOR COVERING PRIVATE DATA

(71) Applicant: Varsha Parikh, Rajasthan (IN)

(72) Inventor: Varsha Parikh, Rajasthan (IN)

(21) Appl. No.: 16/068,135

(22) PCT Filed: Sep. 26, 2017
(86) PCT No.: PCT/IB2017/055874

§ 371 Date: Jul. 5, 2018

(30) Foreign Application Priority Data
Sep. 27, 2016 (IN) 201611032928

(51) Int. Cl. G06F 21/62; G06F 21/60; G06K 9/32; G06K 9/00; G06F 11/14

(52) U.S. Cl. CPC G06F 21/6209; G06F 21/602; G06F 11/1461; G06K 9/3241; G06K 9/00362; G06F 21/6272

(57) ABSTRACT

A method and device for covering private data by detecting inappropriateness in a data and blurring or coloring the data is disclosed. The method and device further includes associating a password with the blurred or colored data and storing the password associated blurred or colored data in a device. The invention further includes synchronizing the data with a remote storage. For synchronization, the invention first determines whether the blurring or coloring was performed correctly or not. If the blurring or coloring was performed successfully, synchronizing the blurred or colored data with the remote storage. If the blurring or coloring was not performed successfully, not synchronizing the original data with the remote storage.

### FIELD OF THE INVENTION

Methods and apparatus consistent with exemplary embodiments relate to a method and a device for blurring data if the data contains any inappropriate content.

### DESCRIPTION OF THE RELATED ART

Nowadays people use cloud account to back up their data like image, video, email, contact etc. So, in case of mobile phone damage, lost, or stolen the data stored in it can still be accessed using the cloud back up. Lately, there have been many incidents of hackers breaking into cloud accounts and distributing data.

With the camera phones, people tend to take images and sometime those images are very intimate or personal, or inappropriate. With cloud back up, such photos create very embarrassing situation in hacking incidents and subsequent distribution via Internet.

People also keep confidential data like important PDF, email etc. on their phones and with automatic synchronization the data gets backed up on the cloud accounts. In security breach scenario, it may cause financial loss.

Even with superior network security, hacking cannot be entirely avoided. A solution is required, so that even if personal pictures or confidential data get into the wrong hand, it should not create embarrassing situation for the individuals.

### SUMMARY OF THE INVENTION

Various exemplary embodiments provide methods and apparatus for making a user's personal data like image, video, any confidential data, or important email, or file make un-viewable or un-recognizable so that in case of leak privacy of the user's personal data is not violated. Hacking of data can happen at the user's cloud account, phone, camera device, PDA, tablet etc. Therefore, it is necessary to keep the data in a form that it does not create embarrassing situation or financial loss in case of hacking incident.

It is difficult to keep entire data in blurred or un-recognizable form and even if that can be done, it will be inconvenient for the user to consume the data. Therefore, various exemplary embodiments provide methods and apparatus for identifying important data or data that might create embarrassing situation or financial loss to user in case of leak. After identifying such data, it is converting it into un-viewable or un-recognizable form by blurring or coloring.

An embodiment can be a method implemented at least in part by a computing device, the method comprising analyzing an image or video data, and if the data is inappropriate or contain nudity, automatically performing blurring or coloring of the data; associating a password with the blurred or colored data. So that, de-blurring or de-coloring of the data can be performed after receiving the password. Any user can access the blurred/colored data and view it. However, original/de-blurred/de-colored data can only be viewed by the user having the correct password.

The embodiment can be implemented as a system comprising, in one or more computer-readable media, an image or video analysis module is configured for analyzing an image or video data and detecting inappropriateness and/or nudity in the data; a blurring or coloring module is configured for blurring or coloring the inappropriate data and associating a password with the blurred or colored data.

### BRIEF DESCRIPTION OF THE DRAWINGS

FIG. 1 is a flow chart illustrating a method for making personal data un-recognizable;

FIG. 2 illustrates an exemplary diagram of an electronic device 200 and its capabilities;

FIG. 3 illustrates an exemplary image processing unit 220 in accordance with the present invention;

FIG. 4 is a flow chart illustrating a method for accessing the blurred/colored data stored on the device;

FIG. 5 is a flow chart illustrating a method for synchronizing data between the local storage and the cloud storage service;

FIG. 6 is a flow chart illustrating a method for handling the inappropriate data when the data cannot be blurred;

FIG. 7 is a flow chart illustrating types of blurring the image or video data stored in the device;

FIG. 8 is a flow chart illustrating conditions for blurring or not blurring the image or video data when nudity is detected in the image or video data;

FIG. 9 is a flow chart illustrating a mechanism to avoid recovery of sensitive data;

FIG. 10 is a flow chart illustrating a method for identifying important data and performing blurring.

FIG. 11 illustrates a method 1100 of alerting a user in accordance with an embodiment of the present invention.

FIG. 12 illustrates a method 1200 of blurring or coloring a data in accordance with an embodiment of the present invention.

FIG. 13 illustrates a method 1300 of performing an overwrite operation data in accordance with an embodiment of the present invention.

### DETAILED DESCRIPTION

The following description of the various exemplary embodiments is illustrative in nature and is not intended to limit the invention, its application, or uses.

Leakage of intimate images or videos create embarrassing situation for people. A software detector may be used to detect inappropriate content like nudity, skin, genitalia, breasts etc. The software detector may be incorporated into camera phones or any electronic device having camera and video capabilities.

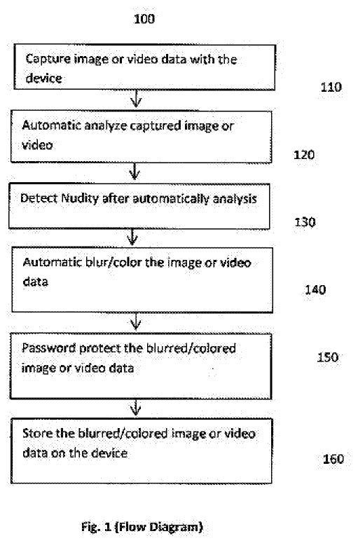

FIG. 1 is a flow chart illustrating a method for making personal data un-recognizable. At step 110, an electronic device having camera and video capabilities captures an image or video data. Subsequently, at step 120, captured data is quickly dissected using the software detector and several aspects of the data may be analyzed and compared to a template. At step 130, the software detector may be adapted to detect the presence of inappropriate content like nudity, skin, genitalia, or breasts etc. After detecting the inappropriate content or nudity, at step 140, the software detector performs blurring or coloring of the captured image or video data. The blurring or coloring may be performed of the entire data or portion(s) of the data that require concealment. At step 150, a password is associated with the blurred or colored data. So that, only after providing the correct password, un-blurring/de-blurring of the data can be done. The password may be user provided or software generated. In case of software generated, the password is communicated to the user via display, text message, email etc. At step, 160, the blurred or colored data is stored on the electronic device.

Blurring is a technique that reduces detail or sharpness of an image. A Guassian blur function can be used to perform blurring of data or portion of data. Other image distortion techniques that make the image or video data un-cognizable, such as occlusions, mosaic blurring, can be used as well.

Coloring, on the other hand, is a technique that uses any color like black, yellow etc. to cover/paint the data or portion of data that need concealment.

De-blurring/de-coloring is a technique to undo blurring/coloring performed on the data. In this process, any artificial blurring/coloring applied to the data is removed.

Nudity or skin can be found in image or video data through various techniques, such as the techniques described in Forsyth and Fleck, “Identifying Nude Pictures.” Proc. of the Third IEEE Workshop, Appl. of Computer Vision, 103-108, Dec. 2-4, 1996, the disclosure of which is incorporated by reference herein in its entirety.

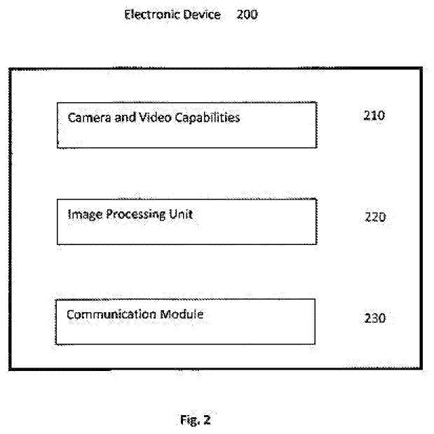

FIG. 2 illustrates an exemplary diagram of an electronic device 200 and its capabilities. The electronic device 200 has camera and video capability 210, an image processing unit 220, and a communication module 230.

The electronic device 200 may be embodied as any computing device, such as a personal computer or workstation, mobile phones, camera phones, digital cameras, digital video recorders (camcorders), personal digital assistants (PDAs) etc. containing a processor 330, such as a central processing unit (CPU), and memory 340, such as Random Access Memory (RAM) and Read-Only Memory (ROM).

The camera and video capability 210 allows a user to capture images and videos by using the electronic device 200.

The image processing unit 220 is described in detail in FIG. 2.

The communication module 230 allows the electronic device to send and receive data from remote server or cloud storage system. The communication module 230 includes the capability of sending and receiving data via a network. The communication module may include a reception unit and a transmission unit.

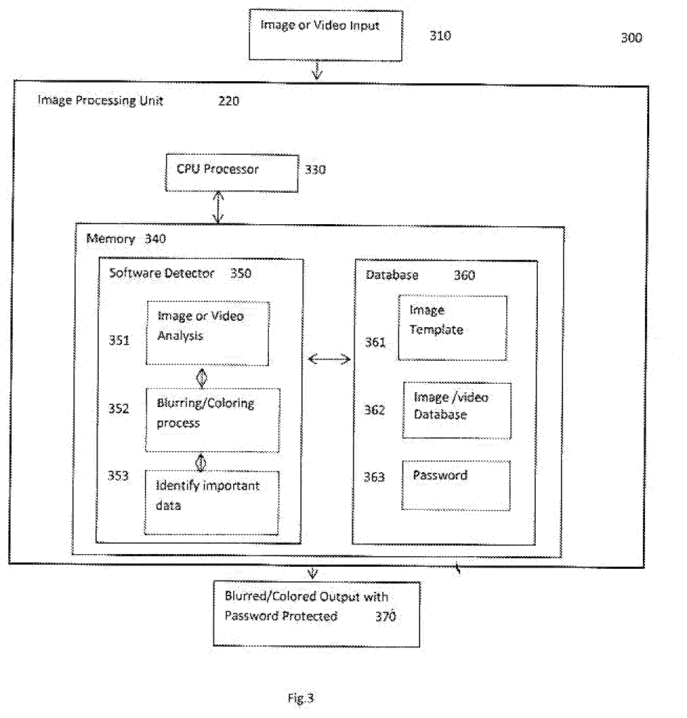

FIG. 3 illustrates an exemplary image processing unit 220 in accordance with the present invention.

According to one aspect of the present invention, the image processing unit 220 receives image or video data as an input and produces blurred/colored output with password protected. The image processing functionality 220 may be provided separate to the CPU processor 330 or by a dedicated programmable hardware accelerator that may be an extension to the CPU 330. In an alternate embodiment, the image processing unit 220 disclosed herein can be implemented as an application specific integrated circuit (ASIC), for example, as part of a video processing system. In an alternate embodiment, the image processing unit 220 disclosed herein can be implemented entirely in software. In another embodiment the image processing unit 220 disclosed herein can be implemented partially in hardware and partially in software.

The image processing unit contains or interacts with software detector and database.

Software Detector is a collection of various modules/programs.

Image or Video Analysis Module

Image or video analysis module performs dissection and/or comparison of captured/stored data and identifies inappropriate content, nudity etc. Image or video analysis module may also perform face detection, face recognition etc. The identification of inappropriate content/nudity, face detection, face recognition performed by Image or video analysis module by using various methods known in the art.

Blurring/De-Blurring, Coloring/De-Coloring Module

Blurring/de-blurring, coloring/de-coloring module performs blurring/de-blurring, coloring/de-coloring of data by using various methods known in the art.

Identify Important Data Module

This module identifies important data oat of available data like email, calendar items, notes, document (PDF, DOC etc.) and text messaging etc. by using various methods known in the art.

Database

Database stores information and makes it available to any application/program/module or end user. Database contains:

Image Template

Image template maintains data that helps software detector in identifying presence of inappropriate content or nudity. Image template may maintain data or pictures related to nudity or skin, genitalia or breasts etc. The image template may also maintain reference pictures of end user/owner, spouse, or others. The reference pictures will help software detector in deciding whether to perform blurring or not, after identifying nudity in the data.

Image/Video Database

Image/video database stores images/videos captured or received by the user. It may store any other data as well. After performing blurring and password protection, image/video data or any other data is stored in the image/video database.

Password

Password database stores randomly generated passwords. These passwords are used by the software detector to associate them with blurred/colored data. The password database may also store user provided passwords for blurred/colored data. The password can be biometric identifiers like fingerprints, retinal scans, pupil scans, or the like.

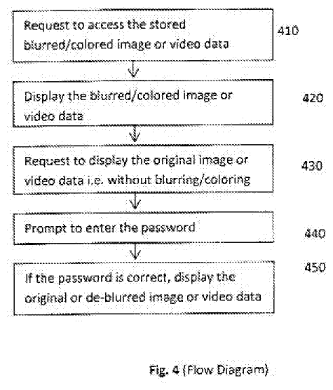

FIG. 4 is a flow chart illustrating a method for accessing the blurred/colored data stored on the device. At 410, a request to access the blurred image or video data is received. At 420, the blurred data is displayed. At 430, a subsequent request to view the original or de-blurred version of the blurred data is received. To view the original data, the user is required to provide the password at 440. If the provided password is correct, display the original data at 450. If the provided password is not correct, do not display the original data.

People use cloud storage service (e.g. Apple iCloud) to back up their data like image, video, email, contact etc. As will be readily appreciated by those skilled in the art, a cloud is a model of networked resources such as storage, computing and applications. Cloud storage service generally refers to electronic storage provided by the cloud via a network.

In still another aspect of the invention, a program or instructions can be executed by the electronic device to perform a method to synchronize data between the device's local storage and a remote storage. Upon receiving a synchronization request, identifying data to be synchronized, and synchronizing the data between the local storage and the remote storage over the one or more networks. As known in the art, synchronization requires sending data from the local storage to the remote storage and/or vice versa.

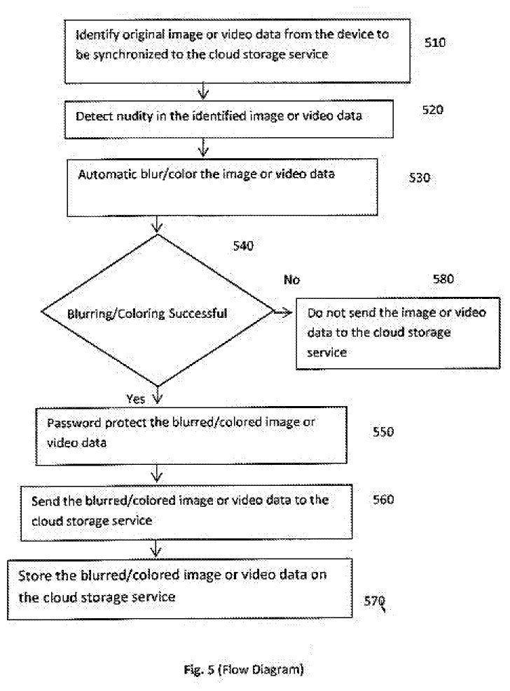

FIG. 5 is a flow chart illustrating a method for synchronizing data between the local storage and the cloud storage service. At 510, image or video data to be synchronized is identified. At 520, the identified data is quickly dissected using the software detector 350 and several aspects of the data may be analyzed and compared to a template. The software detector 350 may be adapted to detect the presence of inappropriate content, nudity or skin, genitalia or breasts. After detecting the inappropriate content or nudity, the software detector 350 performs blurring or coloring of the captured image or video data at 530. The blurring or coloring may be performed of the entire data or portion(s) of the data that require concealment. At 540, it is determined mat whether the blurring or coloring was performed or not. If blurring or coloring was performed correctly, at 550, a password is associated with the blurred or colored data. So that, only after providing the correct password, de-blurring of the data can be done. At 560, the blurred or colored data with password protection is sent to the cloud storage service. At 570, the blurred or colored data with password protected is stored on the cloud storage service. At 540, if it is determined that blurring or coloring was not performed, the image or video data is not sent to the cloud storage service at 580.

Synchronization of data can be performed through various techniques, such as the techniques described for synchronization between a portable device and a remote computer, in Dennis A. Kiilerich, Michael J. Novak, Kevin P. Larkin, “Two-way synchronization of media data”, U.S. Ser. No. 11/420,989, filed May 30, 2006, the disclosure of which is incorporated by reference herein in its entirety.

As per the invention, when inappropriate content like nudity is detected in the image or video data and blurring of the data cannot be performed, the inappropriate data is not transmitted to the cloud storage service. A tag or marker is attached to the inappropriate data so that as long as blurring is not performed, the data is not considered for synchronization. The tag or maker can be attached by the software detector or end user. The blurring or coloring of the data may not be performed due to many reasons like the user has turned off the blurring or coloring process or any other technical reasons.

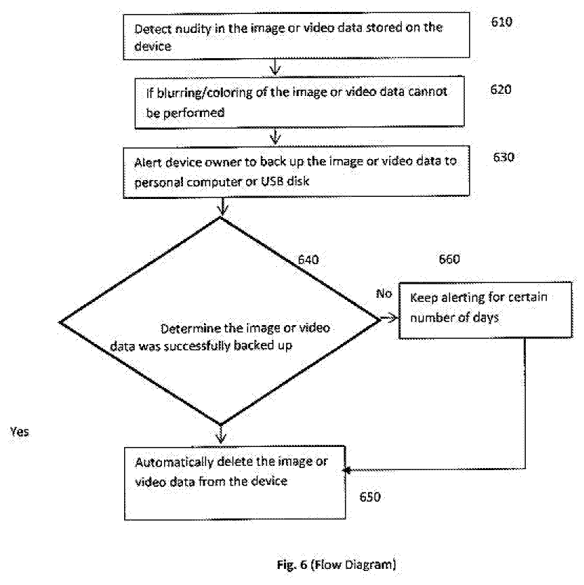

FIG. 6 is a flow chart illustrating a method for handling the inappropriate data when the data cannot be blurred. After determining nudity in the image or video data captured or stored on the user's phone 610, if blurring of the data cannot be performed 620, software detector or any other module alerts the user/owner 630 to back up the image or video data as the data contain nudity and cannot be blurred. After being alerted, the user can back up such data to his/her personal computer or USB disk or any other device which has lesser chances of getting hacked or accessed. At 640, it is determined that whether the user has backed up such data or not. If the user has backed up the data, software detector or any other module automatically deletes the data. If the user has not backed up the data, software detector or any other module keeps alerting the user for a threshold or certain number of days. Even after certain number of days or certain number of alerts, for example 5 (or any threshold), the data is not backed up by the user, software module deletes the data.

It is important to back up inappropriate data and afterwards delete it from a mobile device, because it might create embarrassing situation if someone accesses such data intentionally/unintentionally, and for the same reason such data is not sent/synced to the cloud storage service.

As per the invention, after determining nudity in the image or video data captured or stored on the user's phone 610, software detector or any other module alerts the user/owner 630 to back up the image or video data as the data contain nudity or data is inappropriate. After being alerted, the user can back up such data to his/her personal computer or USB disk or any other device which has lesser chances of getting hacked or accessed. At 640, it is determined that whether the user has backed up such data or not. If the user has backed up the data, software detector or any other module automatically deletes the data.

As per the invention, after determining nudity in the image or video data captured or stored on the user's phone 610, software detector compares the data with a one or more reference pictures. If the data matches with the one or more pictures, software detector or any other module alerts the user/owner 630 to back up the image or video data. After being alerted, the user can back up such data to his/her personal computer or USB disk or any other device which has lesser chances of getting hacked or accessed. At 640, it is determined that whether the user has backed up such data or not. If the user has backed up the data, software detector or any other module automatically deletes the data.

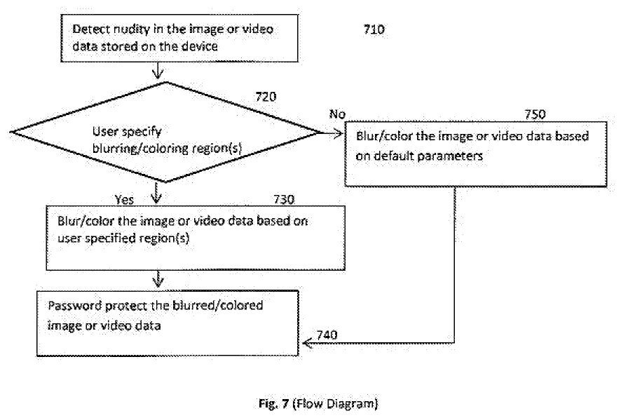

FIG. 7 is a flow chart illustrating types of blurring the image or video data stored in the device. After detecting nudity in the image or video data 710, software detector may prompt a user interface to the user to specify the region (s) to be blurred 720 and based on the user input, performs the blurring 730. Software detector may allow the user to specify generalized parameters for blurring 720 and based on those parameters perform the blurring every time it encounters such data 730. In case there is no parameter available, software detector may perform blurring of the entire data or portion (s) of the data that require concealment 750. At 740, after blurring the data, software detector password protects the blurred data.

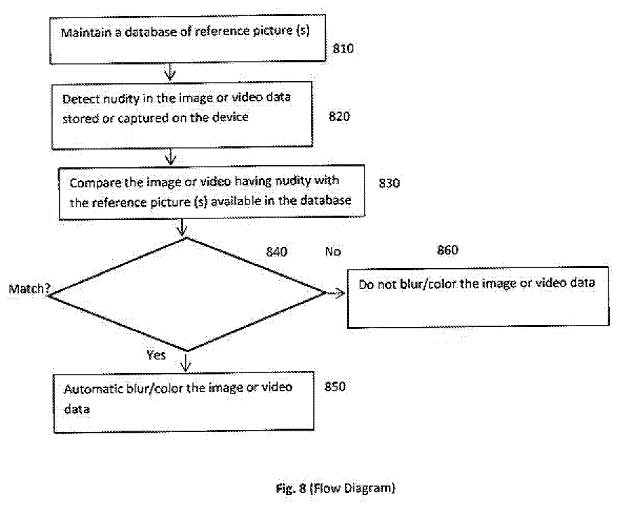

FIG. 8 is a flow chart illustrating conditions for blurring or not blurring the image or video data when nudity is detected in the image or video data.

As per the invention, the user is allowed to maintain reference pictures in the database so that when the software detector finds nudity in any image or video data, it compares face or any other characteristics of the image or video data with the reference pictures 830. If there is match 840, software detector performs blurring of the image or video data 850. If there is not any match 840, it does not perform blurring of the image or video data 860.

To perform the matching, it is required to classify objects in the image. After it is determined that the object is human, it is required to detect a face or any other characteristics end recognize the face or any other characteristics. Classification of objects is described in SrinivasGutta and VasanthPhilomin, “Classification of Objects through Model Ensembles,” U.S. Ser. No. 09/794,443, filed Feb. 27, 2001, the disclosure of which is incorporated by reference herein in its entirely. There are also a variety of techniques for face recognition. The face recognition may be performed in accordance with the teachings described in, Antonio Colmenarez and Thomas Huang, “Maximum Likelihood Face Detection,” 2nd Int'l Conf. on Face and Gesture Recognition, 307-311, Killington, Vt. (Oct. 14-16, 1996) or SrinivasGutta et al., “Face and Gesture Recognition Using Hybrid Classifiers,” 2d Int'l Conf. on Face and Gesture Recognition, 164-169, Killington, Vt. (Oct. 14-16, 1996), incorporated by reference herein in its entirety.

It may be possible that the owner of the device does not want blurring to be performed of all the inappropriate data. In that case he can provide reference pictures of himself/herself and other people like spouse. So, when software detector finds nudity in any image or video data, it compares the image or video data with the reference pictures. If there is a match 840, software detector performs blurring of the data 850. If there is not a match 840, software detector does not perform blurring 860. The reference pictures can be provided by the user or can be selected by the software detector automatically from available image database.

As per the invention, in FIG. 6 at 640, it is determined that whether the user has backed up the data containing nudity as such data is not blurred due to any technical reason. So that, such data can be deleted from the user's device.

Deletion procedure: Most operating systems keep track of data on a hard drive through “pointers”. Each file data on hard disk has a pointer that tells operating systems that where the file's data begins and ends. When data is deleted, operating systems remove the pointer and mark the sectors of the memory containing the file's data as available. Until new data is overwritten over the sectors, the deleted data is recoverable.

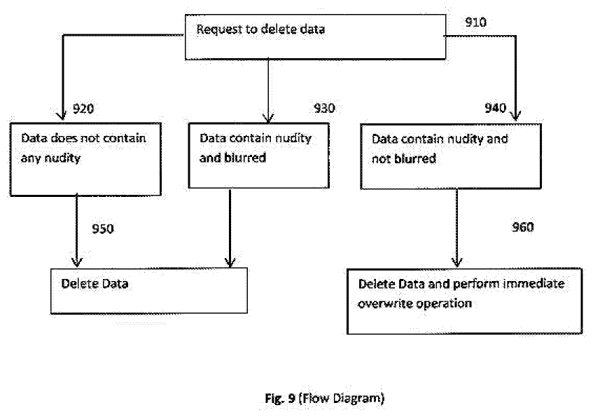

Nowadays, many data recovery tools or programs arc available that can be used to recover any deleted data. In case of sensitive data like intimate images or videos, such recovery must be avoided. FIG. 9 is a flow chart illustrating a mechanism to avoid recovery of sensitive data. When there is a request to delete any data 910, before delete operation being performed, software detector determines that does that data contain any nudity? If there is not any nudity 920, the data is deleted 950. When the requested data contains nudity, but it is blurred or colored 930, it gets deleted 950. In case the requested data does contain nudity and it is not blurred or colored 940, just after deleting the data, automatic over write operation is also performed 960 immediately over the sectors of the deleted data to make the deleted data irrecoverable. The overwrite operation can be performed with a specified overwrite array. The specified array can be any desired pattern of characters or data and can be user defined or default to a pre-defined pattern.

A secure deletion of data using overwrite operation can be performed through various techniques, such as the techniques described in Robert Phillip Starek, George Friedman, David Earl Marshall, and Jason Lee Chambers, “Method and apparatus for real-time secure file deletion”. U.S. Ser. No. 08/940,746, filed 30 Sep. 1997, the disclosure of which is incorporated by reference herein in its entirety.

As per the invention, the immediate overwrite operation does not need to be performed every time after a delete operation. The overwrite operation has to be performed immediately only when the deleted data contained any nudity and the data was not blurred 960.

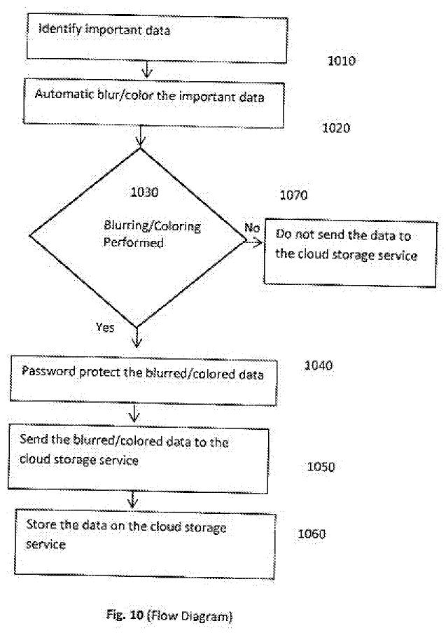

As per the invention, when there is a request to delete any data 910, before delete operation being performed, software detector determines that does that data contain any inappropriateness or is that data important (identification of important data is explained in FIG. 10) to the user? If yes, an immediate overwrite operation is performed at the memory location containing the data.

As per the invention, when there is a request to delete any data 910, before delete operation being performed, software detector determines that does that data contain any inappropriateness? If yes, it compares the data with a one or more reference pictures stored in the database. If the data matches with the one or more reference pictures, software detector performs or software detector indicates the operating system to perform an immediate overwrite operation at the memory location containing the data.

FIG. 10 is a flow chart illustrating a method for identifying important data and performing blurring. As per the invention, software detector finds nudity in the image or video data. Along with that, it also finds important data 1010 out of available data like email, calendar items, notes, documents (PDF, DOC etc.), text messaging etc. Software detector performs various methods like artificial intelligence (AI), natural language processing (NLP) and machine learning to identify important data. The various methods like artificial intelligence (AI), natural language processing (NLP), and machine learning uses keyword, clustering, unsupervised learning, supervised learning, sematic analysis to extract important data to the user.

After identifying the important data 1010, software detector performs blurring/coloring of the identified important data 1020. If blurring/coloring is performed successfully 1030, it password protects the blurred/colored data 1040. At 1050 the blurred/colored data with password protection is transmitted/synchronized to the cloud storage service where data gels stored and accessible to the authorized user. If blurring/coloring is not performed successfully 1030, due to any technical reason, the data is not transmitted/synchronized to the cloud storage service.

As per the invention, the important data may be an email containing business related information, a note storing bank related information, a text message containing private chat, or any other information considered important to the end user. The user also has an option of providing keywords, templates, paragraphs, feedback, tag, marker etc. to guide software detector to identify important data or it can be done automatically by software detector by observing the user's interaction with the data or by finding important keywords in the data.

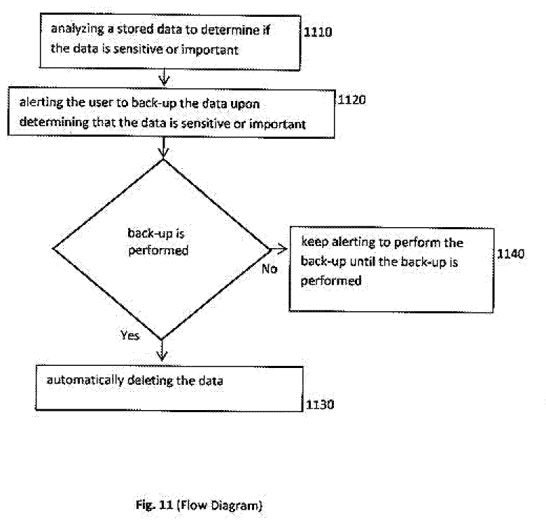

FIG. 11 illustrates a method 1100 of alerting a user in accordance with an embodiment of the present invention.

At step 1110, the method comprises analyzing a stored data to determine if the data is sensitive or important. At step 1120, the method comprises alerting the user to back-up the data upon determining that the data is sensitive or important. At step 1130, the method comprises automatic deletion of data if the backup is performed. In case the backup is not performed, the method comprises frequently alerting the user to perform the back up as shown at step 1140. Such alerts are provided to the user until the backup is performed. The said method 1100 is implemented at least in part by a computing device.

As already mentioned in above paragraphs. The sensitive data includes, being not limited to, image or video data having nudity, skin, genitalia, breasts etc. Also, the important data includes bank related information, business related information, or any other information considered important to the user

In one example, the method includes performing the alert for a threshold number of times. In another example, the back-up is performed by copying the data to devices like USB disk, external disk, remote storage, or any other device having lower chances of getting hacked or illegally accessed.

In another example, the method comprises comparing the data with a one or more reference data upon determining that the data is sensitive or important and if the data matches with the one or more reference data, performing the operation of alerting the user to back-up the data as shown at step 1130 or 1140.

In yet another example, the one or more reference data is provided by the user or automatically determined by the computing device. The one or more reference data includes face or any other characteristic of the user or of people chosen by the user. The one or more reference data may include keywords.

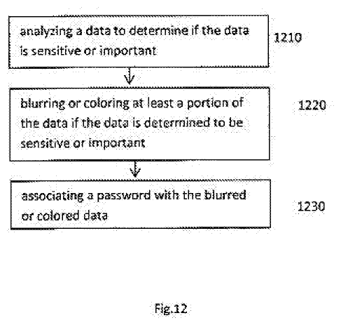

FIG. 12 illustrates a method 1200 of blurring or coloring a data in accordance with an embodiment of the present invention.

At step 1210, the method comprises analyzing a data to determine if the data is sensitive or important. At step 1220, the method comprises blurring or coloring at least a portion of the data if the data is determined to be sensitive or important. At step 1230, the method comprises associating a password with the blurred or colored data.

In one example, the method comprises allowing transmission or synchronization of the data.

In another example, the method comprises receiving a request to view an un-blurred or de-colored version of the blurred or colored data. The method further comprises prompting to enter a password. The method further comprises comparing the entered password with the associated password. In case a match is found, un-blurring or de-coloring the blurred or colored data. The method fun her comprises displaying the un-blurred or de-colored version of the blurred or colored data.

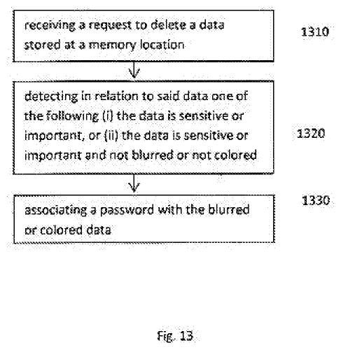

FIG. 13 illustrates a method 1300 of performing an overwrite operation data in accordance with an embodiment of the present invention.

At step 1310, the method comprises receiving a request to delete a data stored at a memory location. At step 1320, the method comprises detecting in relation to said data one of the following (i) the data is sensitive or important, or (ii) the data is sensitive or important and not blurred or not colored. At step 1330, the method comprises performing an immediate overwrite operation at the memory location.

In one example, the method comprises comparing the data with a one or more reference pictures. In case the data matches with the one or more reference pictures, the immediate overwrite operation at the memory location is performed.

I claim:

1. A method implemented by a computing device comprising:
analyzing a stored data to determine if the data is sensitive or important;
comparing the data with a one or more reference data upon determining that the data is sensitive or important; and
if the data matches with the one or more reference data, performing at least one of:
alerting a user to back-up the data;
automatically deleting the data if back-up if the data is performed;
in response to alerting to back-up the data, automatically deleting the data if the back-up is performed;
keep alerting to perform back-up of the data until the back-up is not performed;
blurring or coloring at least a portion of the data;
blurring or coloring at least a portion of the data and associating a password with the blurred or colored data;
alerting the user to back-up the data if blurring or coloring of the data is not performed; and
allowing transmission or synchronization of the data only after blurring or coloring at least a portion of the data, wherein the blurring or coloring also involves associating a password with the blurred or colored data.

2. The method of claim 1, wherein the sensitive data includes image or video data having nudity, skin, genitalia, breasts etc.

3. The method of claim 1, wherein the important data includes bank related information, business related information, or any other information considered important to the user.

4. The method of claim 1, wherein the alert is performed for a threshold number of times.

5. The method as claimed in claim 4, wherein after alerting for the threshold number of times, automatically deleting the data.

6. The method of claim 1, wherein the back-up is performed by copying the data to devices like USB disk, external disk, remote storage, or any other device having lower chances of getting hacked or illegally accessed.

7. The method as claimed in claim 1, wherein the blurring or coloring involves making at least a portion of the data un-recognizable or un-viewable.

8. The method as claimed in claim 1, wherein if the blurring or coloring of the data is not performed, attaching a tag to the data and not allowing the transmission or synchronization of the tagged data.

9. The method as claimed in claim 1, further comprising
determining if the blurring or coloring is successfully performed; and
alerting to back up the data if the blurring or coloring is not successfully performed.

10. The method of claim 1, wherein the one or more reference data is provided by the user or automatically determined by the computing device.

11. The method of claim 1, wherein the one or more reference data includes face or any other characteristic of the user or of people chosen by the user.

12. The method of claim 1, wherein the one or more reference data includes keywords.

13. The method as claimed in claim 1, further comprising allowing the user to decide whether to blur or color the entire data or a portion of the data that require concealment.

14. The method as claimed in claim 1, further comprising allowing the user to specify a region to be blurred or colored.

15. A method implemented by a computing device comprising:
analyzing a stored data to determine if the data is sensitive or important;
upon determining that the data is sensitive or important, performing at least one of:
alerting a user to back-up the data;
automatically deleting the data if back-up of the data is performed;
in response to alerting to back-up the data, automatically deleting the data if the back-up is performed;
keep alerting to perform back-up of the data until the back-up is not performed;
blurring or coloring at least a portion of the data;
blurring or coloring at least a portion of the data and associating a password with the blurred or colored data;
alerting the user to back-up the data if blurring or coloring of the data is not performed; and
allowing transmission or synchronization of the data only after blurring or coloring at least a portion of the data, wherein the blurring or coloring also involves associating a password with the blurred or colored data.

16. A method of alerting a user, the method implemented by a computing device comprising:
analyzing a stored data to determine if the data is sensitive or important;
alerting the user to back-up the data upon determining that the data is sensitive or important; and
if the back-up is performed, automatically deleting the data; and
if the back-up is not performed, keep alerting to perform the back-up until the back-up is performed.

17. A method of performing an overwrite operation, the method implemented at least in part by a computing device comprising:
receiving a request to delete a data stored at a memory location;
detecting in relation to said data one of:
the data is sensitive or important; and
the data is sensitive or important and not blurred or not colored
performing, on said detection, an immediate overwrite operation at the memory location.

18. The method as claimed in claim 17, wherein the overwrite operation involves deleting the data.

19. The method as claimed in claim 17, wherein the overwrite operation makes the data irrevocable.

20. A method of performing an overwrite operation, the method implemented at least in part by a computing device comprising:
receiving a request to delete a data stored at a memory location;
detecting in relation to said data one of:
the data is sensitive or important; and
the data is sensitive or important and not blurred or not colored
comparing upon said detection, the data with a one or more reference pictures; and
if the data matches with the one or more reference pictures, performing an immediate overwrite operation at the memory location.
